(19) United States
(12) Patent Application Publication
(10) Pub. No.: US 2014/0180488 A1
(43) Pub. Date: Jun. 26, 2014

(54) ELECTRONIC APPARATUS, AND CONTROL METHOD AND CONTROL PROGRAM OF THE SAME

(71) Applicant: Kabushiki Kaisha Toshiba, Tokyo (JP)

(72) Inventor: Noriyuki HIRAYAMA, Fuchu-shi (JP)

(73) Assignee: Kabushiki Kaisha Toshiba, Tokyo (JP)

(21) Appl. No.: 13/975,996

(22) Filed: Aug. 26, 2013

Related U.S. Application Data
(63) Continuation of application No. PCT/JP2013/058151, filed on Mar. 21, 2013.

(30) Foreign Application Priority Data
Dec. 26, 2012 (JP) 2012-282769

(51) Int. Cl. G06F 1/32

(52) U.S. Cl. CPC G06F 1/3234
USPC 700/295

(57) ABSTRACT

According to one embodiment, a receiving unit is configured to receive a notification of an application for operation permission based on an operation input from a first device, and a transmitting unit is configured to make a power saving command for a second device based on the application for operation permission, to transmit a notification of an operation start permission to the first device after receiving a response of a power saving operation start from the second device, and to make a notification of an operation restart permission for the second device if a certain period has elapsed after receiving a notification indicating that an operation has been ended from the first device.

### CROSS REFERENCE TO RELATED APPLICATIONS

This application is a Continuation Application of PCT Application No. PCT/JP2013/058151, filed Mar. 21, 2013 and based upon and claiming the benefit of priority from Japanese Patent Application No. 2012-282769, filed Dec. 26, 2012, the entire contents of all of which are incorporated herein by reference.

### FIELD

Embodiments described herein relate generally to an electronic apparatus, a control method of the electronic apparatus, and a control program of the electronic apparatus.

### BACKGROUND

Recently, a power-saving measurement to save an electronic power supplied from a power generating plant of a power supplying company has been required. If total power consumption in a power-supplied region is increased as compared with a quantity of power supply from the power generating plant, a power failure may occur and may cause serious damages at factories, hospitals, etc.

In addition, electric power companies have recently developed smart meters. The smart meters have been supposed to measure household power consumption and control home appliances via home networks. In contrast, some current home appliances, for example, television reception apparatuses, lighting fixtures, etc. are provided with a power saving function.

A system of allowing the electric power companies to notify each home of a request for cooperation of power saving and obtaining a response to the notification from each home has been reviewed. This notification is called a demand response request. In order to allow users to exactly respond to the demand response request, however, the users first have to certainly recognize that the demand response request has arrived.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an illustration showing an example of connected apparatuses in a home network to explain a summary of an embodiment;

FIG. 2 is an illustration separately showing a power supply path and a communication path to the connected apparatuses in the home network in FIG. 1;

FIG. 3A is an illustration showing a typical example of a home appliance control apparatus provided at a home appliance in FIG. 1, as an embodiment;

FIG. 3B is an illustration showing the other typical example of the home appliance control apparatus provided at the home appliance in FIG. 1, as the embodiment;

FIG. 4 is a block diagram showing a configuration example of a television receiver which is a typical home appliance;

FIG. 5 is a flowchart showing an example of operations of the home appliance;

FIG. 6A is an explanatory illustration showing a display example of a display according to the embodiment;

FIG. 6B is an explanatory illustration showing the other display example of a display according to the embodiment;

FIG. 7 is an illustration showing a display example of a power saving table used for power saving at home appliances;

FIG. 8 is an illustration showing an example of the connected apparatuses in the home network to explain a cooperation system of the home appliances for peak shaving of power consumption according to the embodiment; and

FIG. 9 is an explanatory view showing an example of operations of the home appliances for the peak shaving of the power consumption.

### DETAILED DESCRIPTION

Various embodiments will be described hereinafter with reference to the accompanying drawings.

In general, according to one embodiment, there are provided an electronic apparatus, a control method of the electronic apparatus, and a control program of the electronic apparatus which, at execute the cooperation of power saving in response to the demand response request from the electric power company, can reduce the extreme burden such as the limitation of use home appliances or specific electric devices while maintaining the cooperation of power saving.

According to an embodiment of the present disclosure, a receiving unit is configured to receive a notification of an application for operation permission based on an operation input from a first device, and

a transmitting unit is configured

to make a power saving command for a second device based on the application for operation permission,

to transmit a notification of an operation start permission to the first device after receiving a response of a power saving operation start from the second device, and

to make a notification of an operation restart permission for the second device if a certain period has elapsed after receiving a notification indicating that an operation has been ended from the first device.

An embodiment will further be described with reference to the drawings.

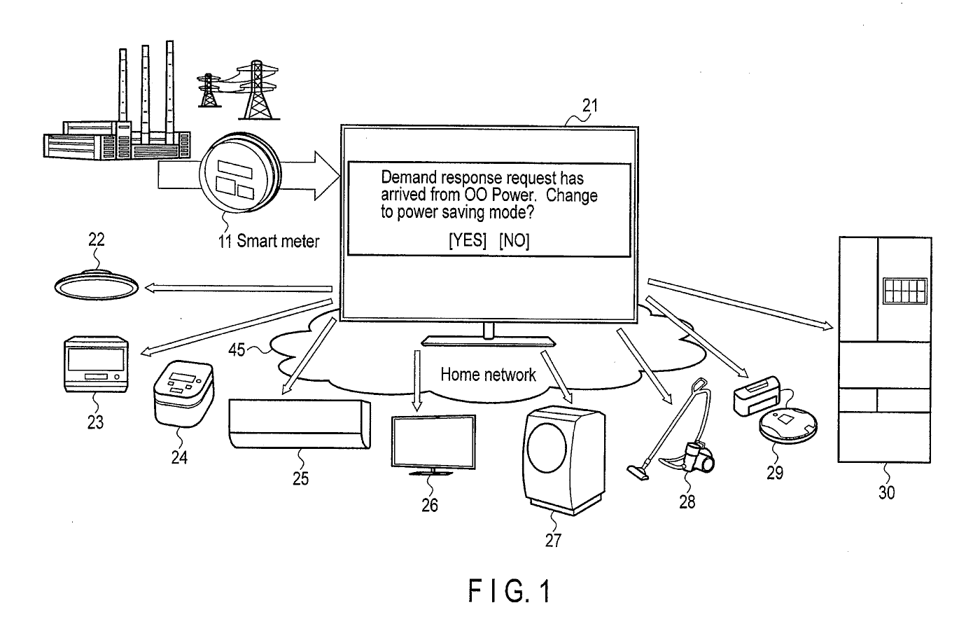

FIG. 1 is an illustration showing an example of connected apparatuses in a home network including a smart meter 11. 21 denotes a television reception apparatus which operates as a main controller. The television reception apparatus does not need to be a main controller of home appliances, but the other device such as a set-top box or a personal computer may be a main controller. The television reception apparatus 21, a lighting fixture 22, a microwave oven 23, an electric rice-cooker 24, an air-conditioner 25, a second television reception apparatus 26, a washer 27, a cleaner 28, an audio player 29, a refrigerator 30, etc. are connected to a wired or wireless home network 45.

Wired or wireless connection in the home network 45 is based on a standard, for example, “ECHONET Lite”, but is not limited to this standard. The “ECHONET Lite” can be employed on a transmission path based on various wired/wireless communication standards, and can be employed for wired/wireless communication which complies with, for example, Ethernet (registered trademark), PLC (Power Line Communication), Wi-Fi, Bluetooth (registered trademark), etc.

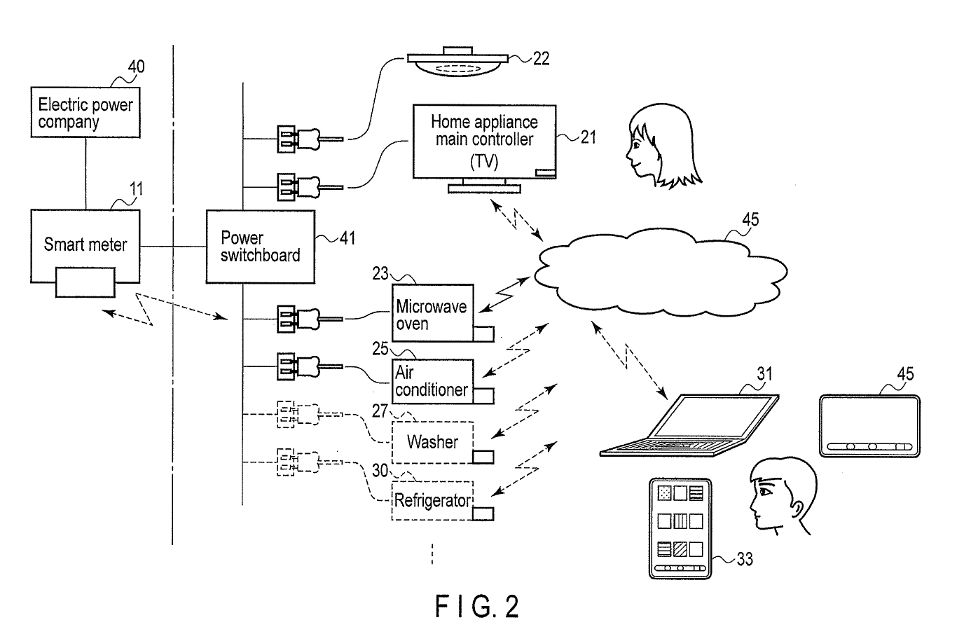

FIG. 2 shows a power supply path and a communication path to the connected apparatuses in the home network in FIG. 1, separately from each other.

An electric power from an electric power company 40 is supplied to a power switchboard 41 via the smart meter 11. The power switchboard 41 distributes the electric power to receptacles at a plurality of indoor portions. Each of home appliances can be supplied the electric power when a plug of the home appliance is inserted into the receptacle. An apparatus which operates with a rechargeable battery such as a mobile terminal (a personal computer 31, a tablet 32, a cell phone 33, etc.) is not often connected to a receptacle.

The smart meter 11 can transmit various types of information to be described below to the home appliances via the home network 45 based on the standard, for example, “ECHONET Lite”. A method of the transmission may be multicast or unicast. The home network does not need to be limited to the standard “ECHONET Lite” since it can be implemented by various near field communication means.

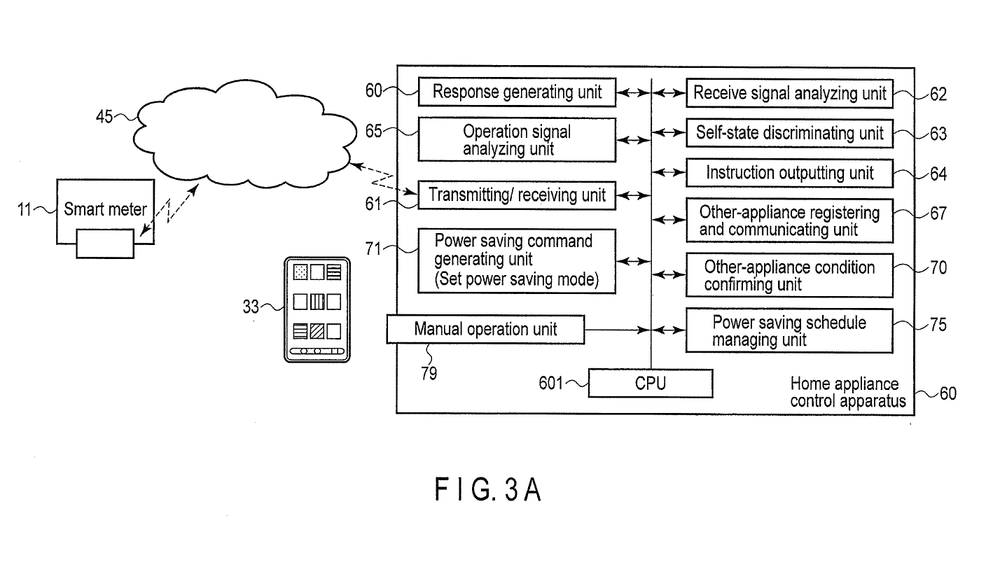

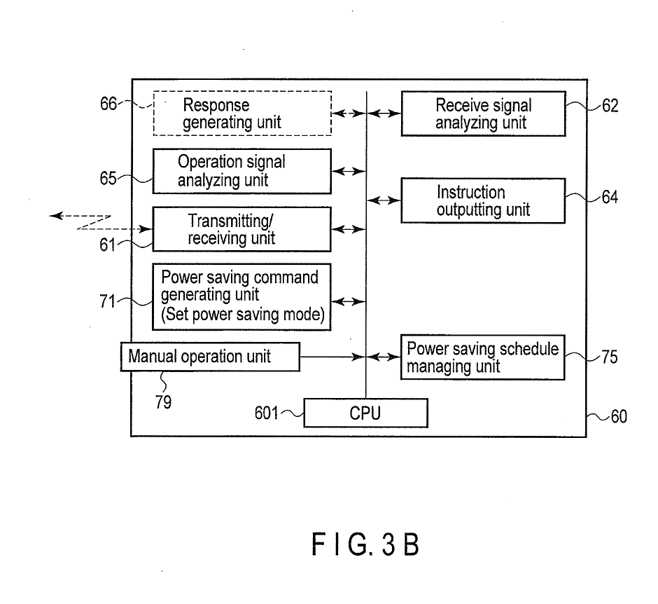

FIG. 3A and FIG. 3B show an embodiment of a home appliance control apparatus 60 provided at the home appliance. The home appliance control apparatus 60 may be implemented by hardware or a software program implementing each function.

A configuration example in FIG. 3A will be first described here. A central processing unit (CPU) 601 executes control of an operation sequence, movement and deletion of data, computation, etc. in each block of operations inside the home appliance control apparatus 60, under programs.

The home appliance control apparatus 60 can execute mutual communication with the smart meter 11 or a control apparatus of the other home appliance via a home network signal transmitting/receiving unit 61.

A receive signal received by the transmitting/receiving unit 61 is analyzed by a receive signal analyzing unit 62, and analysis of instructions or various types of data (apparatus ID, setting data, etc.) is executed. A self-status discriminating unit 63 determines a current status of the home appliance equipped with the home appliance control apparatus 60, for example, whether a current main power supply is in an on state or not, whether a display is in a displayable state or not, which type is the type of the power saving mode, etc.

An instruction outputting unit 64 is capable of outputting various instructions to each of units of the home appliance equipped with the home appliance control apparatus 60. The instructions include, for example, instructions for displaying a message, an operation button, a decision button, etc. on the display. The instructions also include instructions for allowing a message to be output by sound.

Furthermore, the instruction outputting unit 64 is capable of outputting instructions responding to a power saving mode or a power saving command to a control unit of the home appliance. The instructions for illumination include an instruction which allows a voltage/current adjustment instruction to be supplied to a voltage/current control unit. The instructions for the television reception apparatus include an instruction for switching between a full-segment reception state (non-power-saving) and a one-segment reception state (power saving), an instruction for enlargement (non-power-saving) or reduction (power saving) of a display area relative to the display, an instruction for increase (non-power-saving) or reduction (power saving) of brightness of the display, etc. The instructions for the refrigerator include an instruction for setting a refrigeration setting temperature to be lower for a predetermined period (predetermined-period power saving).

An operation signal analyzing unit 65 analyzes operation signals when the user makes manual operation or operation signals input via the transmitting/receiving unit 61. The operation signals include an operation signal for indicating whether cooperation in power saving can be executed or not, an operation signal for setting the power saving mode at the home appliance in accordance with an operation, etc., as described below. The manual operation signal is input via a manual operation unit 79.

A response generating unit 66 generates a response in accordance with the user's operation signal when, for example, a demand response request has arrived from an electric power company. The demand response request is a signal transmitted when the electric power company inquires of the user as to whether the user can execute cooperation in power saving or not. The user needs to respond to the demand response request. When the demand response request has arrived, the user makes a response such as “YES (the user will cooperate in power saving)” or “NO (the user will not cooperate in power saving)”. The response generated in accordance with the user operation at the response generating unit 66 is transmitted to the electric power company via the transmitting/receiving unit 61, the home network 45 and the smart meter 11.

An other-appliance registering and communicating unit 67 is capable of registering other home appliances which can be connected in the home network 45, and of communicating with the other home appliances. For example, the other home appliances are identified by their ID numbers, production numbers, etc. The registration can be implemented in various methods. The methods include, for example, a method of inputting the production number of the home appliance to be registered by the manual operation, in a registration mode by the manual operation, and a method of reading a bar code by an infrared scanner and inputting the bar code. The methods also include a method of reading a bar code to be registered by a camera of a mobile terminal and transferring the bar code to the other-appliance registering and communicating unit 67, and are not limited to one method. In addition, the unit 67 is capable of setting and registering whether the present apparatus operates as a main apparatus or a slave. Furthermore, the unit 67 is also capable of automatically confirming and registering the home appliance connected in the home network 45 by the communication defined under “ECHONET Lite”.

The other-appliance registering and communicating unit 67 is capable of notifying the other registered home appliances of operation conditions of the present apparatus. For example, the other home appliances can be notified of the fact that the response has been made to the demand response request of the electric power company, by the above-described response generating unit 66. At the notification, a notification signal is transmitted via the transmitting/receiving unit 61 and the home network 45.

Furthermore, the other-appliance registering and communicating unit 67 is also capable of, when an operation to activate (power on) the home appliance (for example, the microwave oven) equipped with the present apparatus has been made, inquiring of the main apparatus (for example, the TV) as to whether the operation may be shifted to this activation, as described below. This is because, for example, if the microwave oven is subjected to the main activation and the quantity of power consumption is to exceed a predetermined value, the quantities of power consumption in a plurality of home appliances can be adjusted and can be prevented from exceeding the predetermined value (i.e., peak shaving of the quantities of power consumption can be executed). The main apparatus can monitor the operation conditions of the plurality of home appliances, control the operations of the plurality of home appliances, and control the quantities of power consumption in the home to be lower than a predetermined level.

An other-appliance condition confirming unit 70 is capable of confirming, for example, a power saving condition of the other home appliance registered in the other-appliance registering and communicating unit 67, and of confirming whether the other home appliance has made a response to the demand response request.

The other-appliance condition confirming unit 70 is also capable of giving an instruction to automatically shift to a subsequent operation to the instruction outputting unit 64 in response to a condition to the other home appliance.

A power saving command generating unit (or a power saving mode setting unit) 71 generates an instruction to allow the home appliance equipped with the home appliance control apparatus to save the power. This instruction is transmitted to the control unit of the home appliance directly or via the instruction outputting unit 64.

The power saving command generating unit (or a power saving mode setting unit) 71 generates an instruction for power saving, in accordance with the manual operation input or power saving information of a power saving schedule managing unit 75. The power saving information includes information such as details of power saving (various power saving types according to the home appliance such as “strong”, “middle” and “weak”), a time zone of the power saving operation, conditions for shifting to the power saving operation, cancellation of power saving, etc., as described below.

The above-described home appliance control apparatus 60 is an example and may be the home appliance control apparatus 60 having a configuration shown in FIG. 3B. The configuration in FIG. 3B does not comprise the self-status discriminating unit 63, the other-appliance registering and communicating unit 67, and other-appliance condition confirming unit 70, and is simpler than the configuration in FIG. 3A. This apparatus is built in, for example, an audio apparatus. However, design and production costs for producing the home appliance control apparatus 60 as shown in FIG. 3A and separating an unnecessary block or function as needed from the produced home appliance control apparatus 60 are smaller than the costs for producing the home appliance control apparatus 60 in FIG. 3A and the home appliance control apparatus 60 in FIG. 3B separately from each other.

In FIG. 3A and FIG. 3B, the configuration is divided into blocks for respective functions. However, this division is an example, and each of the blocks may be called means or function. Each block may be further divided into smaller blocks for the respective functions, and combination of the smaller blocks may be constructed.

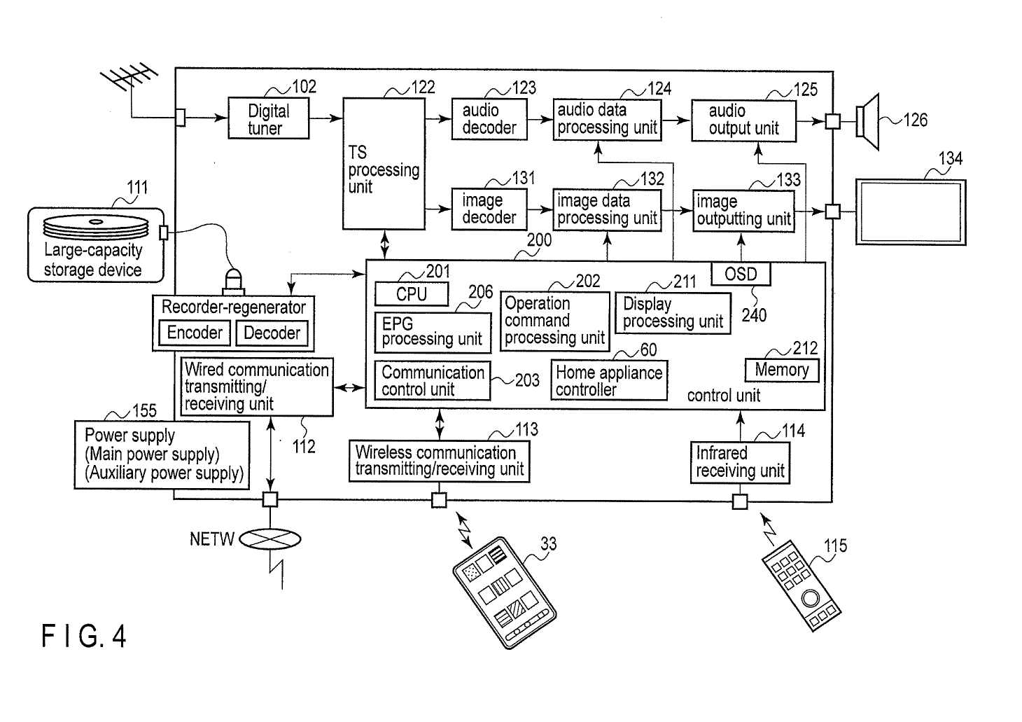

FIG. 4 shows an example of an overall configuration of the television reception apparatus 21 equipped with the home appliance control apparatus 60. The television reception apparatus 21 may be replaced with a data storing/regenerating apparatus. 102 denotes a digital tuner. A plurality of tuners are built in the tuner 102, and are capable of simultaneously receiving signals over a plurality of channels and demodulating a plurality of broadcast programs. A high frequency signal received by an antenna via an input terminal is input to the tuner 102. The tuner 102 may comprise, for example, a tuner (not shown) for receiving BS/CS digital broadcasting.

An input terminal BN1 is an external input terminal. Signals from a cable, a network or the other appliances are input to the input terminal.

The broadcast program signals received by the tuner 102 and the signals from the external input terminal BN1 are input to a TS processing unit 122. TSs (Transport Streams) of a plurality of channels (CHs) are re-multiplexed to one TS. The multiplexed TS includes a packet sequence of the broadcast programs of each channel. Identification information for identifying the channels and packets is added to the packets of each channel. The multiplexed TS is input to a storage device 111 via a control unit 200 and a recorder-regenerator. The packets including control information, in the TS input to the TS processing unit 122 is input to the control unit 200 and decrypted.

The storage device 111 comprises, for example, a hard disk drive or an optical disk recording and regenerating device. The optical disks include a digital versatile disk (DVD), a Blu-ray disk (BD) (registered trademark), etc.

The packets including the control information as input from the TS processing unit 122 to the control unit 200 include, for example, ECM (Entitlement Control Message) which is the encrypted information of the broadcast programs, information such as EIT (Event Information Table) which is a table describing event information such as program names, performers, program start times, etc., and EPG (Electric Program Guide) information. The EPG information often includes sponsor information.

Image data included in the packets is encoded in, for example, MPEG (Moving Picture Expert Group), AVC (Advanced Video Coding), etc. In addition, audio data in audio packets is encoded in, for example, PCM (Pulse Code Modulation), Dolby, MPEG, etc.

Therefore, packets including the audio data, of the packets separated in the TS processing unit 122, are input to an audio decoder 123. The data in the packets is decoded in accordance with encoding, in the audio decoder 123. The audio data decoded in the audio decoder 123 is subjected to synchronization, volume adjustment, etc. in an audio data processing unit 124, and is supplied to an audio output unit 125. The audio output unit 125 executes stereo separation according to a speaker system and supplies an output to a speaker 126.

The packets including the image data, of the packets separated in the TS processing unit 122, are input to an image decoder 131. In the image decoder 131, data of the packets is decoded in accordance with the encoding scheme. The image data decoded in the image decoder 131 is subjected to synchronization, brightness adjustment, color adjustment, etc. in an image data processing unit 132. An output of the image data processing unit 132 is supplied to an image outputting unit 133. The image outputting unit 133 is capable of multiplexing data, figures, program tables, various menu images, operation button images, etc. input from the control unit 200 via an on-screen display (OSD) unit 240.

The image outputting unit 133 sets a scale, a resolution, number of lines, an aspect ratio, etc. according to a display 134, for an output image signal, and outputs the image data to the display 134.

Audio packets and image packets of a pay program are often encrypted. In this case, a processing system for decryption using key information is provided but is omitted here.

The control unit 200 comprises a central processing unit (CPU) 201, an operation command processing unit 202, a communication control unit 203, an operation device management unit 204, an EPG (Electric Program Guide) data processing unit 206, a display processing unit 211, and a memory 212.

The control unit 200 also comprises a keyword-related information processing unit, a keyword registration unit and a CM processing unit. The control unit 200 further comprises a record control unit, etc. but they are not shown.

The EPG data processing unit 206 holds, for example, program information of programs in one previous month, at a present time and in one next month by extracting the program information from the packets included in the TS and storing the program information. The program information is updated on each day.

The CPU 201 adjusts a total operation sequence of the control unit 200. The operation command processing unit 202 is capable of analyzing an operation command input from the outside and reflecting an operation responding to the command on the television reception apparatus. The operation device management unit 204 is capable of confirming device identification data of a mobile terminal 33, a remote controller 115, etc. which transmit operation signals to the control unit 200, and of managing an acceptance of input, a denial of acceptance, etc.

The display processing unit 211 is capable of totally controlling the image signal displayed on a display 134 via the image outputting unit 133. The display processing unit 211 is also capable of adjusting a resolution, a display size, a display area, etc. of the image signal. In addition, the display processing unit 211 is capable of supplying a menu image signal generated in the control unit 200 in accordance with an operation signal and an image signal of a program table generated by using EPG data, to the image outputting unit 133, via the OSD 240. The memory 212 is capable of storing various types of data, applications, etc. stored in the control unit 200.

The communication control unit 203 is capable of communicating with the outside and receiving an operation command, data, a content, etc. The received content and data can be stored in, for example, the storage device 111 or the memory 212. The communication control unit 203 is capable of transmitting data, a content, etc. from the television reception apparatus to the outside.

The communication control unit 203 is connected with a wired communication transmitting/receiving unit 112 and a wireless communication transmitting/receiving unit 113. The wired communication transmitting/receiving unit 112 is capable of transmitting data to or receiving data from a remote server or a home server via the Internet. The wireless communication transmitting/receiving unit 113 is a unit designed for near field communication and is capable of transmitting data or a content to or receiving data or a content from the mobile terminal 33. The television reception apparatus is also capable of receiving an operation signal from the remote controller 115 via an infrared receiving unit 114.

The mobile terminal 33 is capable of remote control of the television reception apparatus.

The mobile terminal 33 is capable of accessing to a server via a base station (not shown), the Internet, etc. The mobile terminal 33 is capable of downloading not only a content provided by the server, but also various applications, game software, etc. and transferring the downloaded content, applications and game software to the control unit 200 via the wireless communication transmitting/receiving unit 113. In addition, the mobile terminal 33 is capable of transferring information (for example, a web server address, a mail address, a network address, etc.) to obtain the content to the control unit 200 via the wireless communication transmitting/receiving unit 113.

The communication control unit 203 operates when the content, application or game software is transferred from mobile terminals 33.

The communication control unit 203 stores the received content in the memory 212. The content may be stored in the storage device 111 in accordance with an operation command or automatically. The storage device 111 is capable of recording the received content in, for example, a hard disk. The content is managed as a content file in the hard disk.

The menu image signal, the image signal of the program table, etc. are stored or managed in the display processing unit 211. When the menu and the program table are displayed, menu screen data and program table data are read from a data storing unit (memory or hard disk) and supplied to the display processing unit 211 under control of the CPU 201. The images of the menu and the program table are thereby displayed on the display 134.

The menu image signal, the image signal of the program table, etc. can be transmitted to the mobile terminal 33. When the mobile terminal 33 requests the menu, program table, etc., the display processing unit 211 can transmit the image signal of the menu and the image signal of the program table under control of the CPU 201.

The mobile terminal 33 allows the menu and the program table to be displayed on a screen of a touch panel, and the user can give an operation command signal to the television reception apparatus by touching an operation button displayed on the screen of the touch (or point) panel. The user can execute data processing associated with the program table and a key word by using the mobile terminal 33.

In addition, the television reception apparatus 21 comprises a power supply 155. The power supply 155 comprises a main power supply and an auxiliary power supply. The auxiliary power supply is activated in a sleep state, and maintains a remote controller receiving circuit, a transmitting/receiving unit for communication, etc. in an operable state. When a substantial power-on signal is input from a remote controller, the main power supply is activated to supply the electric power to the entire blocks in the television reception apparatus 21.

The control unit 200 comprises the home appliance control apparatus 60 shown in FIG. 3A. An example of operations mainly focused on the home appliance control apparatus 60 will be described here.

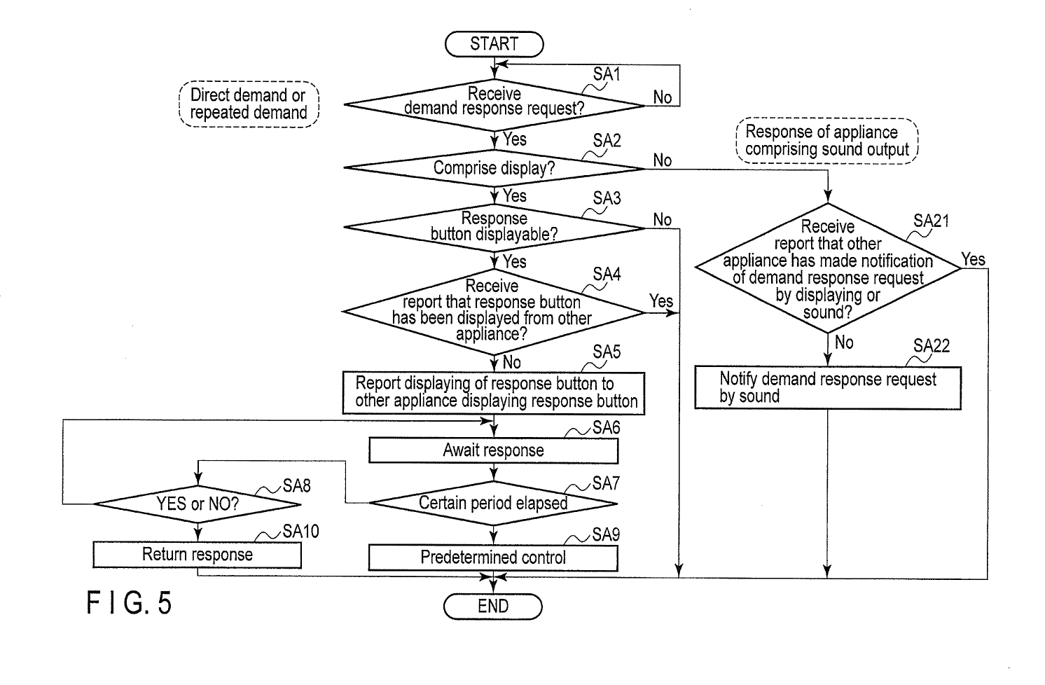

FIG. 5 is a flowchart showing the example of operations of the home appliance control apparatus 60. The example of operations can include an example of the operations of the television reception apparatus 21 which functions as the main controller, an example of the operations of the personal computer 31, the tablet 32 or the cell phone 33 which operates as the slave, an example of the operations of the player 29 and an example of the operations of the refrigerator 30.

The example of operations will be described as follows. If the demand response request is received from the electric power company, the apparatus determines whether the own apparatus comprises a display or not (steps SA1 and SA2). The display indicates, for example, a liquid crystal display which can display the image data. If the apparatus does not comprise a display, the apparatus would be, for example, an audio device such as a player, a cleaner, a microwave oven, an electric rice-cooker, an air-conditioner, a lighting fixture or the like. If the apparatus comprises a display, the apparatus would be a television reception apparatus, a personal computer, a mobile terminal or the like.

If the apparatus comprises a display, the apparatus discriminates whether a response button can be displayed on the display or not (step SA3). The case where the response button cannot be displayed indicates that the electric power is not supplied to the display and that if the apparatus is, for example, the television reception apparatus, the television reception apparatus is in the power-off state or the personal or that if the apparatus is, for example, the personal computer, the personal computer is in the power-off state. If the response button can be displayed, the display is in the operable state.

If it is determined that the response button cannot be displayed in step SA3, the processing is ended.

If it is determined that the response button can be displayed in step SA3, it is discriminated in subsequent step SA4 whether the apparatus receives from the other appliance a report “the response button displayed on the other appliance”. If the other appliance already displays the response button on the other appliance, the household user would recognize the “demand response request from the electric power company”. Therefore, the processing is ended in this case.

If the report “the response button displayed on the other appliance” is not received from the other appliance in step SA4, the response button is displayed in step SA5. Then, the report “the response button displayed” is made for the other appliance (i.e., the other appliance based on other appliance registration data).

After the report, a user' response input of “YES” or “NO” is awaited (step SA6). If the input “YES” or “NO” from the user is made within a predetermined period, the response is returned to the smart meter and the processing is ended (steps SA7, SA8, and SA10).

If there is no response input of “YES” or “NO” from the user after awaiting for a predetermined period, predetermined control is executed and the processing is ended (steps SA7 and SA9).

The predetermined control is, for example, to transmit a transmit signal to cancel the notification that “the response button has been displayed” as transmitted to the other appliance in step SA5.

If it is determined in step SA2 that the apparatus does not comprise the display, the home appliance equipped with the control apparatus is, for example, an acoustic apparatus such as a player, a cleaner, or a microwave oven. In this case, the processing shifts to step SA21 and it is determined whether the other appliance has “output a notification of the demand response request from the electric power company” or “displayed the response button” by display or sound. This determination can be executed since the report is transmitted by multicast or unicast by the other appliance similarly the operation in previous step SA5.

If the report that the other appliance has already “output a notification of the demand response request from the electric power company” or “displayed the response button” is received, the processing is ended. However, if the report is not received, the notification of the demand response request from the electric power company is output by sound. The sound output may by a speech message, a predetermined chime, or a combination of the message and the chime.

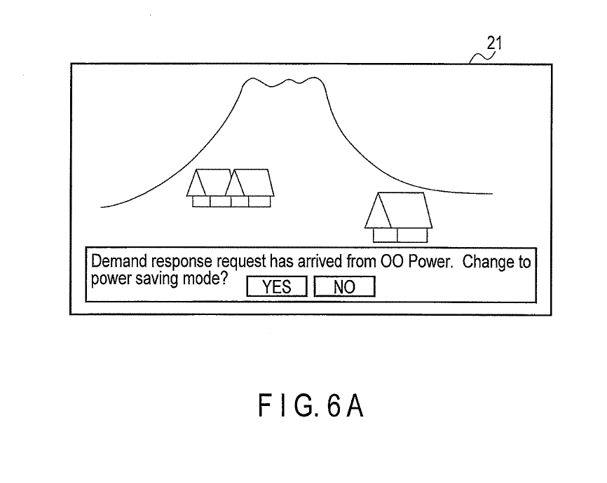

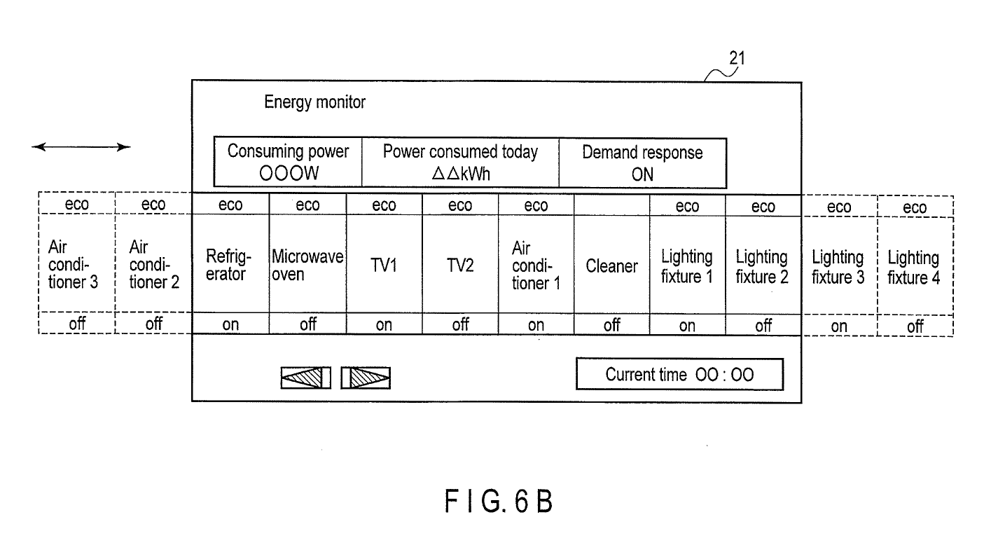

FIG. 6A shows a screen in a case where, for example, the demand response request has arrived while the user is watching a program at the television reception apparatus 21. For example, a message “A demand response request has arrived from OO Power. Change to power saving mode?” is displayed on the screen. Operation buttons “YES” and “NO” for the user to respond to the request are also displayed. The user selects either of the operation buttons and pushes down a decision button by operating the remote controller.

In the home appliance control apparatus 60 in the television reception apparatus 21, the other appliance registering and communicating unit 67 is provided as shown in FIG. 3A. The home appliances which are capable of mutual communication via the home network, for example, the microwave oven 23, the washer 27, the cleaner 28, etc. are registered in the other appliance registering and communicating unit 67. In a state in which the menu is displayed on the display of the television reception apparatus 21, for example, if an item “energy monitor” is selected by a cursor and the decision button is pushed down by the operation of the remote controller, current operated states (ON, OFF, power saving state, etc.) of the home appliances are displayed.

FIG. 6B shows an example of display of an energy monitor display. An amount of the currently consumed power, the electric power consumed on the present day (for example, an amount of the electric power consumed from 0 o'clock AM until the present time), and whether the user makes a response “YES” to the demand response request, are displayed on the monitor image. If the user makes the response “YES”, the demand response “ON” is displayed.

Furthermore, the current states of the registered home appliances are displayed. In the example shown in the figure, the refrigerator is understood to be in the power saving mode (eco) at “on”. It is also understood that the microwave oven is in the power saving mode (eco) at “off”, TV1 is in the power saving mode (eco) at “on”, TV2 is in the power saving mode (eco) at “off”, air conditioner 1 is in the power saving mode (eco) at “on”, the cleaner the cleaner is not in the power saving mode at “off”, lighting fixture 1 is in the power saving mode (eco) at “on”, lighting fixture 2 is in the power saving mode (eco) at “off”, lighting fixture 3 is in the power saving mode (eco) at “on”, lighting fixture 4 is in the power saving mode (eco) at “off”, air conditioner 2 is in the power saving mode (eco) at “off”, and air conditioner 3 is in the power saving mode (eco) at “off”.

In FIG. 6B, the lighting fixture 3, the lighting fixture 4, the air conditioner 2 and the air conditioner 3 are presented by dotted lines since they are out of the screen of the television reception apparatus 21. The data of the home appliances is registered in the other appliance registering and communicating unit 67. When the screen is in the displayable state, the screen can be scrolled by placing the cursor on the name of the home appliance and operating an arrow button of the remote controller. The state of any one of the home appliances, i.e., the lighting fixture 3, the lighting fixture 4, the air conditioner 2 and the air conditioner 3 can be displayed at the center of the screen by the scrolling. Furthermore the current time can also be displayed on the screen. The user can thereby know in what state the home appliance is in the current time band.

In the television reception apparatus 21, the other appliance condition confirming unit 70 (shown in FIG. 3A) confirms the state of each of the home appliances by the mutual communication with each of the home appliances. Furthermore, a power saving schedule can be set in each of the home appliances, which will be described later. The power saving schedule is registered in the power saving schedule managing unit 75 shown in FIG. 3A. The power saving command generating unit 71 can set the power saving mode in accordance with the power saving schedule.

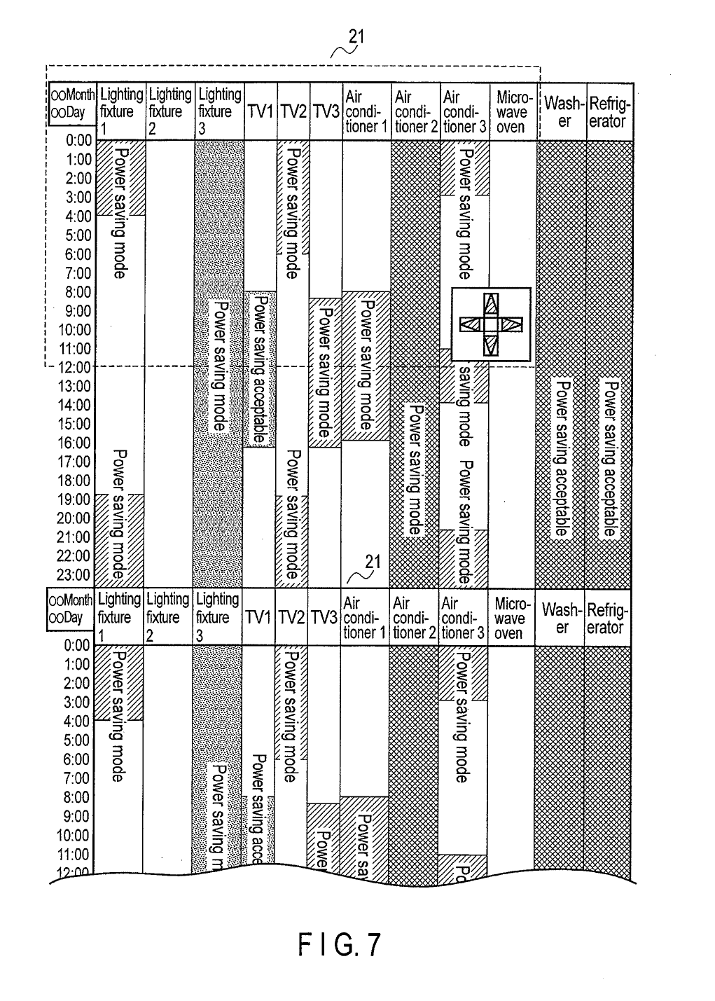

FIG. 7 shows an example of an image for setting the power saving mode for each of the home appliances on the screen of the television reception apparatus 21. In the image for setting the power saving mode, for example, the name and the symbol of the home appliance are displayed by a horizontal axis while the time zone is displayed by a vertical axis. The table image appears when an item “set power saving mode” or “set saving energy” is selected on the menu screen. The user can select the time zone of the each of the home appliances by the cursor operation. When the time zone is selected, the user can operate an energy saving button for the time zone and set the “power saving mode” operation for the time zone. The “power saving mode” operation may be simultaneously set for all of the home appliances in the selected time zone.

In the example in FIG. 7, it is indicated that the lighting fixture 1 is in the power saving mode, i.e., set to be in the “power saving mode” in the time zones 0:00-4:00 and 20:00-0:00. It is indicated that the lighting fixture 3 is in the “power saving mode” in all of the time zones. An image of the time zones, home appliances, etc. which are not displayed in the screen (i.e., a region surrounded by a dotted line) of the television reception apparatus 21 is displayed in the screen by operating an arrow operation button of the remote controller.

Furthermore, the user can select the time zone and select “off” for power saving. In other words, the time zone in which “off” is set indicates that the home appliance is not operated.

In addition, a mode called “power saving mode acceptable” is set at the TV1, the cleaner and the refrigerator. In a case where “power saving mode acceptable” is set, for example, when the power saving request arrives from the main controller, the operation mode can be automatically shifted to the power saving mode (for example, suspension for a certain period, a power saving operation, or the like).

If various power saving modes, “power saving acceptable”, “off” according to the time zone, etc. as described above can be set, various aspects can be obtained. Various settings may be set as the type of the power saving mode to execute power saving.

The appropriate power saving mode is set in accordance with the function and the use condition of each of the appliances such as the electric rice-cooker, the washer, and the regenerating apparatus.

For example, an intermittent power-on/off mode may be employed. Alternatively, a power saving mode of executing the power saving and power off for a certain period and then returning may also be employed.

When the power saving mode shift confirmation screen (YES or NO) is displayed in response to the demand response request from the electric power company, in the present embodiment, if a first appliance is powered off (i.e., the screen cannot be displayed), the confirmation screen (YES or NO) can be displayed on a screen of a second appliance, and if the second appliance is also powered off, a third appliance can notify the user of the power saving confirmation by sound.

In the present apparatus, the home appliance controller can comprise a calendar function and set possibility to accept the demand response request for each date and each time zone. When the demand response request is received from the electric power company in the time zone in which the demand response request is set to be acceptable, the home appliance serving as the controller shifts to the power saving mode without displaying the power saving mode shift confirmation screen on the screen of the home appliance (controller appliance) serving as the controller, such that a power saving mode change instruction can be sent from the home appliance serving as the controller to all of the home appliances in the home network.

The following response can also be made. When the home appliance serving as the controller receives the demand response request from the electric power company in the time zone in which the demand response request is set to be unacceptable, the home appliance serving as the controller does not shift to the power saving mode without displaying the power saving mode shift confirmation screen on the screen of the home appliance serving as the controller, such that no power saving mode change instruction can be sent from the home appliance serving as the controller to all of the home appliances in the home network. Acceptance of the demand response request can be set on the table of the power saving schedule managing unit 75 as shown in FIG. 7.

Furthermore, the following response can also be made. When the demand response request is received from the electric power company in the time zone in which acceptance of the demand response request is not set, the power saving mode shift confirmation screen is displayed on the screen of the home appliance serving as the controller and, only when the user approves shift to the power saving mode, the home appliance serving as the controller shifts to the power saving mode, such that the power saving mode change instruction can be sent from the home appliance serving as the controller to all of the home appliances in the home network.

Moreover, when the user accepts the demand response request from the electric power company, the home appliance serving as the controller can inquire the operation modes of all of the home alliances in the home network and send the power saving mode shift instruction to an appliance which is not in the power saving mode. In response to a demand response cancellation request from the electric power company, the home appliance controller can send a general mode shift instruction to the only home appliance to which the power saving mode shift instruction has been sent. Alternatively, in a case where the user accepts the demand response request, the home appliance controller may send the power saving mode shift instruction to all of the home appliances in the home network and obtain information of a home appliance which has been in the power saving mode prior to sending the shift instruction and, at shifting to the general mode, the home appliance controller may send the general mode shift instruction to the appliances other than the home appliances which have been in the power saving mode at sending the instruction, of the home appliances to which the power saving mode shift instruction has been sent, based on the information.

In the present embodiment, as described above, the power saving mode can be set at the home appliances and the setting information can be used in various aspects.

Operations in the power saving mode in the power saving schedule may be in the operable state at any time or may be set to be automatically activated when the “demand response request from the electric power company” has arrived.

Alternatively, the operations in the power saving mode in the power saving schedule may be set to be activated after the “demand response request from the electric power company” has arrived and the user has made the response “YES” to the request.

Furthermore, an operation for setting all of the home appliances to be in the power saving mode over all of the time zones may be made in the setting of the power saving schedule.

When the schedule in one day is set, the schedule is repeated every day. In the embodiment, however, the power saving schedule of the home appliances can be set based on the calendar. In this case, different power saving modes can be set in accordance with the date and time. For example, the power saving mode is set at all of the dates and times, but a setting of canceling the power saving mode on Sunday, from 20 o'clock to 21 o'clock, can be made.

In addition, a “power saving mode cancellation permitting signal” is often sent from the electric power company. In this case, according to the embodiment, when the user makes a response “YES” to the “demand response request from the electric power company” and the operation is shifted to the power saving mode operation in accordance with the response, the operation mode can be returned to the previous operation mode. The previous operation mode is, for example, a state in which no power saving operation is executed or a state in which the operation is executed on the power saving schedule. If the power saving schedule is set to save the electric power at any time, the state of operating based on the power saving schedule is the previous operation mode. If the power saving schedule is set to make an operation responding to the “demand response request from the electric power company”, the state of operating irrespective of the power saving schedule is the previous operation mode.

Moreover, the system of the embodiment can implement peak shaving (or peak cutting) of the power consumption in the household system. The peak shaving operation indicates an operation of automatically suppressing the current power consumption so as not to exceed a certain level.

The peak shaving operation may be started when the response “YES” is made to the demand response request as described above. Alternatively, the start timing may not be specified and the peak shaving operation may be executed at any time in response to the user's settings. The peak shaving operation is also the feature of the present embodiment.

The peak shaving operation will be described here. For example, the television reception apparatus 21 is assumed to operate as the main controller.

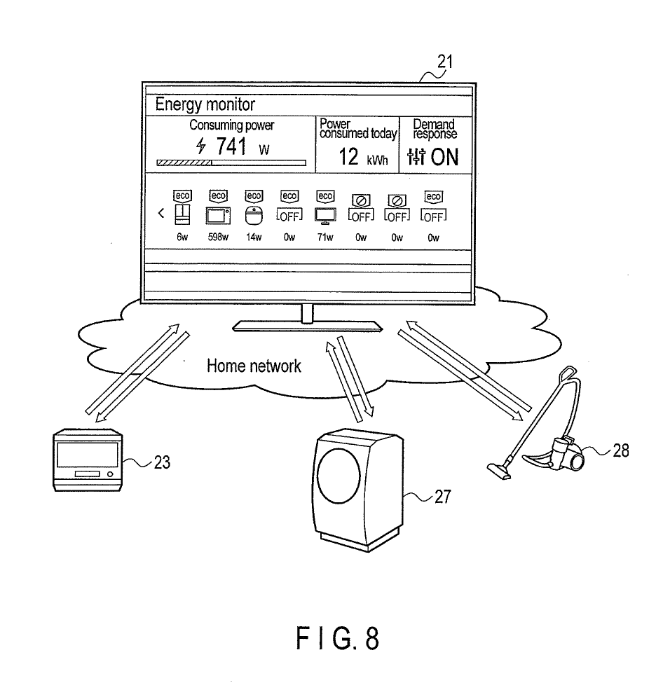

The other-appliance registering and communicating unit 67 is provided in the home appliance control apparatus 60 in the television reception apparatus 21 as shown in FIG. 8. The home appliances which are capable of mutual communication via the home network, for example, the microwave oven 23, the washer 27, and the cleaner 28, etc. are registered in the other-appliance registering and communicating unit 67. In a state in which the menu is displayed on the display of the television reception apparatus 21, for example, if an item “energy monitor” is selected by a cursor and the decision button is pushed down by the operation of the remote controller, current operated states (ON, OFF, power saving state, etc.) of the home appliances are displayed.

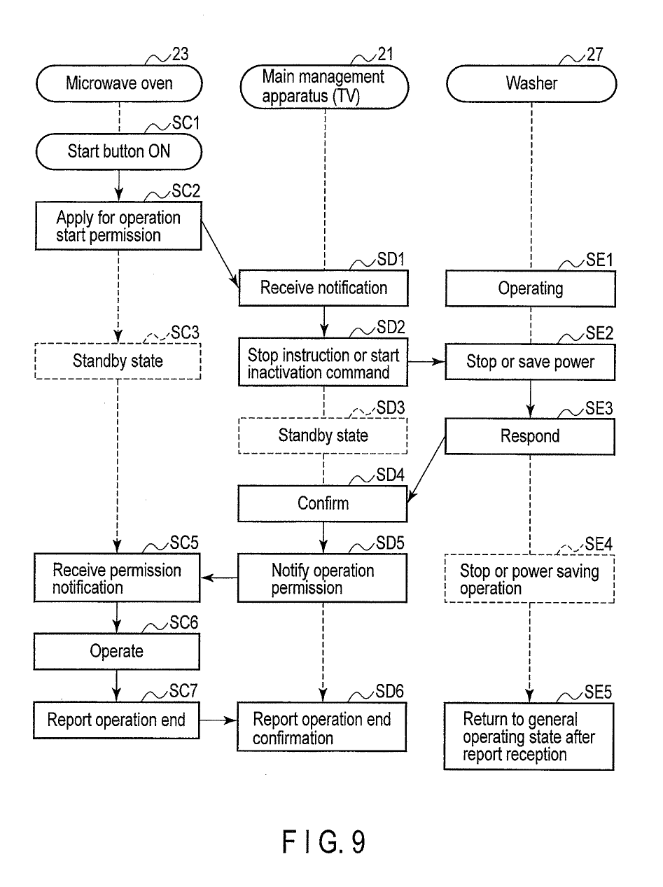

It is assumed that the washer 27 is currently working (step SE1) as shown in FIG. 9. Furthermore, the user is assumed to currently operate an on button to use the microwave oven 23 (step SC1).

The household power consumption is calculated to exceed a set value although this condition is definitely necessary. Alternatively, it is assumed that the household power consumption may exceed a preset peak. In this case, the home appliance control apparatus in the microwave oven sends an application for operation start permission to a main management apparatus (the television reception apparatus 21 in this example) (step SC2) and shifts to a standby state (step SC3). This operation is executed mainly by the operation signal analyzing unit 65 and the other-appliance registering and communicating unit 67 in the microwave oven (see FIG. 3A).

If the main management apparatus 21 receives a notification (step SD1), the main management apparatus 21 sends a stop instruction or a start inactivation command to, for example, the washer 27 (step SD2) and shifts to the standby state (step SD3). This operation is executed mainly by the transmitting/receiving unit 61, the receive signal analyzing unit 62, the power saving schedule managing unit 75, the instruction outputting unit 64, the other-appliance registering and communicating unit 67, etc. in the main management apparatus 21 (television reception apparatus 21).

The washer 27 receives the stop instruction or the start inactivation command and stops the operation or shifts to the power saving operation (step SE2). Then, the washer 27 sends a response to the main management apparatus 21 to notify stopping or shifting to the power saving operation (step SE3), and stops or changes to the power saving operation (step SE4). This operation is executed mainly by the transmitting/receiving unit 61, the receive signal analyzing unit 62, the self-status discriminating unit 63, the instruction outputting unit 64, the power saving command generating unit 71, the other-appliance registering and communicating unit 67, etc. of the washer 27.

If the main management apparatus 21 receives the response from the washer 27, the main management apparatus 21 sends an operation permission notification to the microwave oven 23 (step SD5). This operation is executed mainly by the transmitting/receiving unit 61, the receive signal analyzing unit 62, the self-status discriminating unit 63, the instruction outputting unit 64, the other-appliance registering and communicating unit 67, etc.

When the microwave oven 23 receives an operation permission notification (step SC5), the microwave oven 23 becomes in an operation start state for the first time (step SC6). When cooking is ended and the operation is completed, the microwave oven 23 notifies the main management apparatus 21 that the operation has been ended. This operation is executed mainly by the transmitting/receiving unit 61, the receive signal analyzing unit 62, the self-status discriminating unit 63, the other-appliance registering and communicating unit 67, etc.

When the main management apparatus 21 confirms that the operation of the microwave oven 23 has been completed (step SD6), the main management apparatus 21 sends a command cancellation signal to the washer 27 to cancel the command which has been previously sent (step SD6). When the command cancellation signal is received by the washer 27, the washer 27 shifts to the previous full operation state.

According to the operation, when the washer 27 is not in the power saving mode, the main management apparatus 21 controls the washer 27 such that the washer 27 temporarily shifts to the power saving mode.

However, the operation is not limited to this and, when the washer 27 is already operated in the power saving mode, the main management apparatus 21 can send a notification of the operation start permission to the microwave oven 23 without establishing communication with the washer 27.

The embodiment is not limited to the above-described operation. For example, when the microwave oven 23 is operated to be turned on, the notification of the operation start permission of sound, etc. may be made and the operation may be shifted to a substantial operation after a lapse of a certain period. This is because the user is expected to manually execute the power saving operation of the other appliances during the lapse of the certain period.

Alternatively, the main management apparatus 21 may make a “temporary stop request” for the other home appliances during the lapse of the certain period when the response “YES” is made to the demand response request.

After the operation has been stopped, the microwave oven may notify the main management apparatus of the stop of the operation after the lapse of the certain period. In this case, when the main management apparatus receives a notification that the operation has been stopped from the microwave oven, the main management apparatus may make a notification of operation restart permission for the home appliance (washer) which has stopped operating as described above. As shown in FIG. 7, however, the power saving mode does not need to be canceled in the home appliance which is preset in the power saving mode in accordance with the time zones. In other words, the power saving mode is set with priority in the control apparatus.

In the above descriptions, a simple example has been prescreened for easy understanding of the descriptions, but is not limited to the above-described embodiment. Basically, the home appliance serving as the controller as described here can give the power saving instruction to all of the home appliances in the home network at receiving the demand response request from the electric power company, and can give the power saving instruction to all of the home appliances in the home network in accordance with the instructions from the user.

In one embodiment, when the home appliance applying for the operation permission starts the operation, the home appliance notifies the home appliance serving as the controller of the application for the operation start permission and, after receiving the notification of the operation start permission from the home appliance serving as the controller, starts the operation. When the home appliance serving as the controller receives the notification of the application for the operation start permission from the home appliance, the home appliance serving as the controller can send a stop request to the other home appliance and, after receiving the response that the operation has been stopped, send the notification of the operation start permission to the home appliance, at the power saving operation based on the demand response request.

In another embodiment, when the home appliance serving as the controller receives the notification of the application for the operation start permission from the home appliance which has applied for the operation permission, the home appliance serving as the controller can send the notification of the operation start permission to the home appliance which has applied for the operation permission, without sending the stop request to the other home appliance if the other home appliance is in the power saving operation based on the user operation.

In yet another embodiment, when the home appliance which has applied for the operation permission starts the operation, the home appliance may make the notification of the operation start to the home appliance serving as the controller and make the notification by sound or the like. The sound is, for example, “Wait a moment”, “Operation will start after O minutes” or the like. Then, the home appliance which has applied for the operation permission starts the operation after the elapse of the certain period. When the home appliance serving as the controller receives the notification for the operation start from the home appliance which has applied for the operation permission, the home appliance serving as the controller can send the stop request to the other home appliances at the power saving operation under the demand response instruction. The other home appliance is shifted to the power saving mode, based on the stop request. Thus, when the other home appliance completes shifting to the power saving mode, the certain period has elapsed and the home appliance which has applied for the operation permission starts the operation.

In yet another embodiment, when the home appliance which has applied for the operation permission stops the operation (i.e., when the processing is ended), the home appliance which has applied for the operation permission notifies the home appliance serving as the controller of the stop of the operation after the elapse of the certain period, after the user operation. Subsequently, when the home appliance serving as the controller receives the notification of the stop of operation from the home appliance which has applied for the operation permission, the home appliance serving as the controller can send the operation restart request to the home appliance which has previously stopped, at the power saving operation based on the demand response request.

In this case, even if the home appliance serving as the controller receives the notification that the operation has been started again from the home appliance which has applied for the operation permission, the home appliance serving as the controller can control the home appliance which has made the operation restart request to start no operation until the certain period has elapsed.

Thus, when the home appliance which has applied for the operation permission stops the operation and restarts the operation of the home appliance after the certain period, for example, every time the microwave oven repeats turning on and off the heating operation, the washer does not repeat turning on and off.

In the above descriptions, when the home appliance which has applied for the operation permission stops the operation, this home appliance sends the notification of the stop of operation to the controller after awaiting the elapse of the certain period, but the control may be executed by the controller. In other words, the home appliance which has applied for the operation permission may notify the controller of the stop of operation immediately when the own appliance stops the operation, and the controller may restart the operation of the other home appliance when the certain period has elapsed after the notification.

The controller may execute the control in accordance with whether the home appliance which has applied for the operation permission is the appliance expected to frequently repeat the operations of turning on and off or not. The appliance which frequently repeats the operations of turning on and off is, for example, an oven and, if the appliance is not an oven, it is, for example, an air conditioner.

In other words, when the controller is notified of the stop of operation from the home appliance which has applied for the operation permission, the controller may discriminate the type of the home appliance in accordance with an appliance identifier included in the notification and, after a different period according to the type of the home appliance which has applied for the operation permission has elapsed, may restart the operation of the other home appliance. Alternatively, after receiving the notification of the operation stop from the home appliance which has applied for the operation permission, the controller may immediately restart the operation of the other home appliance without awaiting the elapse of the certain period if the home appliance which has applied for the operation permission is a predetermined appliance. The controller may set a wait period from the reception of the operation stop notification until the transmission of the operation restart request, for each home appliance which has applied for the operation permission or in accordance with the type of the home appliance which has applied for the operation permission. This setting may be executed in response to the user operation.

When the controller receives the notification of the operation stop from the home appliance which has applied for the operation permission and causes the other home appliance to return, the controller may make the operation restart request for the other home appliance after the different period according to the type of the other home appliance has elapsed. In other words, if a destination of sending of the operation restart request is an appliance which, unpreferably, frequently repeats turning on and off, the wait period from the reception of the operation stop notification until the transmission of the operation restart request maybe set to be long. If the destination of sending of the operation restart request is an appliance which frequently repeats turning on and off without problems, the wait period may be set to be short. The controller can set the wait period in accordance with each home appliance which is the destination of transmission of the operation restart request, based on the user operation.

In the above descriptions, the term “unit” is in the category of the embodiments even if the term is replaced with “apparatus”, “device”, “block” or module”. Furthermore, the components of claims are in the category of the embodiments even if the components are expressed separately, even if the components are expressed in association with each other or even if the components are expressed in combination with each other. Even if the claims are expressed as methods, the apparatus is applied to the methods.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic apparatus comprising:
a receiving unit configured to receive a notification of an application for operation permission based on an operation input from a first device; and
a transmitting unit configured
to make a power saving command for a second device and, after receiving a response of a power saving operation start from the second device,
to transmit a notification of an operation start permission to the first device, if the notification of the application for operation permission is received, and
to make a notification of an operation restart permission for the second device if a certain period has elapsed after receiving a notification indicating that an operation has been ended from the first device.

2. The apparatus of claim 1, wherein the power saving command is made for the second device if the second device is set to accept a power saving mode based on a demand response request.

3. The apparatus of claim 1, wherein when the notification of the application for operation permission is received from the first device,
the transmitting unit transmits the notification of the operation start permission to the first device without making the power saving command for the second device if the apparatus is in a state of shifting to a power saving operation mode.

4. The apparatus of claim 1, wherein when the notification of the application for operation permission is received from the first device,
the transmitting unit transmits the notification of the operation start permission to the first device without making the power saving command for the second device if a third device is in a state of shifting to a power saving operation mode.

5. The apparatus of claim 1, wherein when the notification indicating that the operation has been ended from the first device,
the transmitting unit ends without making the notification of the operation restart permission for the second device if the second device is in a preset state of a power saving operation mode.

6. The apparatus of claim 1, wherein when the notification indicating that the operation has been ended from the first device,
the transmitting unit makes the notification of the operation restart permission for the second device if the certain period different according to the second device has elapsed.

7. The apparatus of claim 1, wherein when the notification indicating that the operation has been ended from the first device,
the transmitting unit makes the notification of the operation restart permission for the second device if the certain period different according to the first device has elapsed.

8. An electronic apparatus comprising:
a setting unit configured to transmit a notification of an application for operation permission to a controller based on an operation input, and to set a standby state;
a starting unit configured to start an operation if a notification of an operation start permission is received during a period of the standby state; and
a transmitting unit configured to transmit a notification of an operation end to the controller if a certain period has elapsed after the operation started based on the notification of the operation start permission has been ended.

9. An electronic apparatus comprising:
a unit configured to transmit a notification of an application for operation permission to a controller based on an operation input, and to set a standby state;
a starting unit configured to start an operation according to a certain period elapsing in the standby state; and
a transmitting unit configured to transmit a notification of an operation end to the controller if the certain period has elapsed after an end of the started operation,
wherein the certain period is a period from a time when the controller makes a power saving command for other device based on the notification of the application for operation permission until a time when the other device shifts to a power saving mode.

10. The apparatus of claim 9, further comprising a unit configured to output predetermined speech based on the operation input.

11. A method of controlling an electronic apparatus,
the apparatus comprising a signal transmitting/receiving unit and a control unit, and being configured to:
receive a notification of an application for operation permission based on an operation input from a first device;
make a power saving command for a second device and, after receiving a response of a power saving operation start from the second device, transmit a notification of an operation start permission to the first device, if the notification of the application for operation permission is received; and,
transmit a notification of an operation restart permission for the second device if a certain period has elapsed after receiving a notification indicating that an operation has been ended from the first device.

12. A control program of an electronic apparatus comprising a signal transmitting/receiving unit and a control unit, the program comprising:
a command to cause the signal transmitting/receiving unit to receive a notification of an application for operation permission based on an operation input from a first device;
a command to cause the control unit to make a power saving command for a second device and, after receiving a response of a power saving operation start from the second device, transmit a notification of an operation start permission to the first device, if the notification of the application for operation permission is received; and,
a command to transmit a notification of an operation restart permission for the second device if a certain period has elapsed after receiving a notification indicating that an operation has been ended from the first device.
